(19) United States
(12) Patent Application Publication
(10) Pub. No.: US 2009/0074166 A1
(43) Pub. Date: Mar. 19, 2009

(54) Expected wait time system with dynamic array

(75) Inventors: James Pavlic, Akron, OH (US); Mark Purdy, Kent, OH (US); Ryszard Antonczyk, Copley, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Virtual Hold Technology, LLC., Akron, OH (US)

(21) Appl. No.: 11/901,186

(22) Filed: Sep. 14, 2007

(51) Int. Cl. H04M 11/00; G06F 9/46

(52) U.S. Cl. 379/201.01; 718/104

(57) ABSTRACT

An expected wait time calculation system generates an expected wait time value representing a time duration expected to elapse before a subject client is connected to a resource for servicing. The expected wait time calculation system comprises an interface to a work force management system for obtaining an indicator of a quantity of resources available for servicing clients. An interface to a queuing system obtains an indicator of a queue position of the subject client. A FIFO array stores a plurality of measured time intervals, each representing a time period between two successive resource queue decrement events. The measured time intervals may be stored in a chronological order. An average time interval, or rate, calculator determines an average time interval by calculating an average of a selected quantity of those most recently measured time intervals from the FIFO array or a rate by dividing a unit of time by the average time interval. An expected wait time calculator determines an expected wait time value as a function a quantity of clients expected to be serviced prior to the subject client multiplied by the average time interval or divided by the rate.

### TECHNICAL FIELD

The present invention relates to calculating a predicted duration of time a client is expected to wait before being connected to a resource for servicing. More particularly, the present invention relates to generating an expected wait time value as a function of a rate of queue decrement events calculated from a quantity of queue decrement events that varies in proportion to the quantity of resources available for servicing clients.

### BACKGROUND OF THE INVENTION

Automatic call director (ACD) technology is a well known technology that: i) accepts incoming calls from calling clients; ii) queues calling clients on hold for connection to a service representative; and iii) when a service representative is available, connects the customer from the queue to the available service representative.

ACD systems also include expected wait time systems which, as a courtesy, notify a caller of the predicted time which the caller will need to wait in queue until a service representative is available. Several models exist for calculating expected wait time.

For example, a rate at which individual calls enter and exit a specific queue may be calculated. The rate is calculated by measuring the time interval between service representative answer events (e.g. a call leaves the queue). A group of the most recent measured time intervals (e.g. a sampling array) may be averaged to determine an expected rate. An expected wait time may then be calculated by dividing a caller's position in the queue by the expected rate.

A problem with such a system is that the accuracy of the estimated wait time is dependent on the accuracy of the expected rate. Further, the size of the sampling array significantly effects the accuracy of the expected rate. For example, if a very small sampling array is used, the rate becomes quite erratic as each new sample has a large influence on the calculated average. Correspondingly, if a very large sampling array is used, each new sample has very little impact on the calculated average and yields a result where the calculated average, being slow to change, may become inaccurate.

What is needed is a system and method for improving the accuracy of an expected wait time calculation and, more particularly, improving the accuracy of an expected wait time calculation in an environment wherein a work force of resources available for servicing clients changes over various time periods through out the day.

### SUMMARY OF THE INVENTION

The present invention comprises an expected wait time calculation system which is adapted to operate with a queuing system and generate an expected wait time value representing a time duration expected to elapse before a subject client is connected to a resource for servicing.

In one aspect, the expected wait time calculation system may comprise an interface to a work force management system for obtaining an indicator of a quantity of resources available for servicing clients and an interface to a queuing system for obtaining an indicator of a queue position for the subject client.

An expected wait time model calculates the expected wait time value as a function a quantity of clients expected to be serviced prior to the subject client multiplied by central tendency time interval, such as an average time interval—or divided by a rate.

The central tendency time interval may be a central measurement, such as an average, of a selected plurality of measured time intervals, each between two successive resource queue decrement events. The selected plurality of measured time intervals may be a certain quantity of most recent measured time intervals that is a dynamic function of the quantity of resources available for servicing clients. The rate may be a unit of time divided by the central tendency time interval.

The dynamic function of the quantity of resources available for servicing clients may be a proportion calculation comprising multiplying the quantity of agents available for servicing clients by a predetermined value. The proportion calculation may be a direct proportion wherein the predetermined value is independent of the quantity of resources available for servicing clients.

Further, because the queuing system may include multiple queues for distinct resource groups, the interface to the workforce management system may further obtain an indicator of a first quantity of resources available in a first resource group for servicing clients in a first queue and a second quantity of resource available in a second group, distinct from the first group, for servicing clients in a second queue.

The interface to the queuing system may further obtain an indicator of which of the first queue and the second queue the client's queue position is within.

As such, the selected plurality of measured time intervals may be: i) measured time intervals for the first queue if the client is positioned within the first queue; and ii) measured time intervals for the second queue if the client is positioned within the second queue. Further, the quantity of resources available for servicing clients may be: i) the quantity of resources available in the first resource group if the client is within the first queue; and ii) the quantity of resources available in the second resource group if the client is within the second queue.

In a second aspect, the expected wait time calculation system may comprise an interface to a work force management system for obtaining an indicator of a quantity of resources available for servicing clients and an interface to a queuing system for obtaining an indicator of a queue position of the subject client.

A FIFO array stores a plurality of measured time intervals. Each measured time interval representing a time period between two successive resource queue decrement events. The FIFO array stores, the plurality of measured time intervals in a chronological order.

A central tendency time interval calculator determines a central tendency time interval, such as an average time interval, by calculating a central measurement, such as an average, of a selected quantity of those most recently measured time intervals from the FIFO array; and/or ii) a rate. The rate may be a unit of time divided by the. central tendency time interval. The selected quantity of measured time intervals may be determined as a dynamic function of the quantity of resources available for servicing clients.

An expected wait time calculator determines an expected wait time value as a function a quantity of clients expected to be serviced prior to the subject client multiplied by the central tendency time interval or divided by the rate.

Again, the dynamic function of the quantity of resources available for servicing clients may be a proportion calculation comprising multiplying the quantity of agents available for servicing clients by a predetermined value. The proportion calculation may be a direct proportion wherein the predetermined value is independent of the quantity of resources available for servicing clients.

Again, because the queuing system may include multiple queues for distinct resource groups, the interface to the workforce management system may further obtain an indicator of a first quantity of resources available in a first resource group for servicing clients in a first queue and a second quantity of resource available in a second group, distinct from the first group, for servicing clients in a second queue.

The interface to the queuing system may further obtain an indicator of which of the first queue and the second queue the client's queue position is within.

As such, the FIFO array may comprise a first FIFO array storing a plurality of measured time intervals for the first queue and a second FIFO array storing a plurality of measured time intervals for the second queue. Such plurality of measured time intervals for the first queuing may be distinct from the plurality of measured time intervals for the second queue.

In this aspect, the central tendency time interval calculator may determine: i) a first queue central tendency time interval by calculating an central measurement, such as an average, of a first selected quantity of those most recently measured time intervals from the first FIFO array; and ii) a second queue central tendency time interval by calculating an central measurement, such as an average, of a second selected quality of those most recently measured time intervals from the second FIFO array.

The expected wait time calculator may determine the expected wait time value: i) as a function of the quantity of clients expect to be serviced prior to the subject client multiplied: i) the first central tendency time interval if the client is within the first queue; and ii) the second central tendency time interval if the client is within the second queue.

Another aspect of the present invention comprises a method of operating an expected wait time system for generating an expected wait time value representing a time duration expected to elapse before a subject client is connected to a resource for servicing.

The method may comprise: i) obtaining an indication of a quantity of resources available for servicing clients; ii) obtaining an indication of a queue position of the subject client; iii) storing, in a chronological order, a plurality of measured time intervals, each representing a time period between two successive resource queue decrement events; iv) calculating a central tendency time interval by calculating a central measurement, such as an average, of a selected quantity of those most recently measured time intervals and/or calculating a rate as a unit of time divided by the central tendency time interval; and v) calculating the expected wait time value as a dynamic function a quantity of clients expected to be serviced prior to the subject client multiplied by the average time interval; and vi) providing an indication of the expected wait time to the subject client.

Again, the dynamic function of the quantity of resources available for servicing clients may be a proportion calculation comprising multiplying the quantity of agents available for servicing clients by a predetermined value. The proportion calculation may be a direct proportion wherein the predetermined value is independent of the quantity of resources available for servicing clients.

Again in this aspect the queuing system may include multiple queues for distinct resource groups, the method may further comprise obtaining an indicator of which of the first queue and the second queue the client's queue position is within.

Further, obtaining an indication of a quantity of resources available for servicing clients comprises obtaining an indicator of a first quantity of resources available in a first resource group for servicing clients in a first queue and an indicator of a second quantity of resource available in a second group, distinct from the first group, for servicing clients in a second queue.

The selected plurality of measured time intervals may be: i) measured time intervals for the first queue if the client is positioned within the first queue; and ii) measured time intervals for the second queue if the client is positioned within the second queue; and

The quantity of resources available for servicing clients may be: i) the quantity of resources available in the first resource group if the client is within the first queue; and ii) the quantity of resources available in the second resource group if the client is within the second queue.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWINGS

FIG. 1 is a block diagram representing an exemplary architecture for queuing clients for resources and generating an expected wait time for a client in accordance with one embodiment of the present invention;

FIG. 2 is a block diagram representing an exemplary architecture for queuing clients for resources and generating an expected wait time for a client in accordance with a second embodiment of the present invention;

FIG. 3 is a diagram representing mathematical relationships of an expected wait time model in accordance with an embodiment of the present invention;

FIG. 4 is a table representing an array size model in accordance with an embodiment of the present invention;

FIG. 5 is a table representing an exemplary dynamic FIFO array and corresponding mathematical relationships for average time intervals and rates in accordance with an embodiment of the present invention;

FIG. 6 is a flow chart representing exemplary operation of an expected wait time calculation model in accordance with an embodiment of the present invention; and

FIG. 7 is a table representing exemplary dynamic FIFO arrays for a plurality of resource groups in accordance with an embodiment of the present invention

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

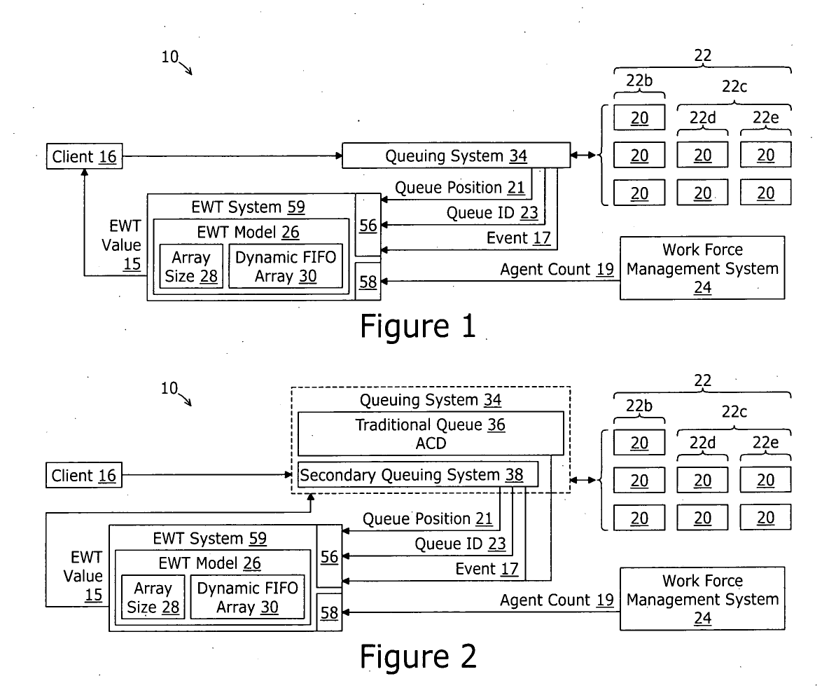

FIG. 1 represents an overview of a system 10 for providing an expected wait time value 15 to a client 16 queued by a queuing system 34 for servicing by a resource 20.

Each client 16 may be a telephony connection established over a traditional PSTN circuit or a communication session established utilizing alternative technologies such as Voice over Internet Protocol (VOIP) or other web interactions.

In an exemplary embodiment, the queuing system 34 may queue clients 16 for multiple resources. Each resource 20 may be a service representative system for enabling a service representative to take a call from a client 16 and service the requests of clients 16. The resources 20 may be for a single group of resources or may be for resources 20 divided into resource groups based on the skill set of the service representative using the resource 20.

For example, each resource 20 may include similar structure for enabling a service representative to perform his or her duties, however, resource group 22b may be resources 20 which are operated by Spanish speaking service representatives while resource group 20c may be resources 20 operated by English speaking service representatives. Subgroup 22d may be primary recourses 20 operated by English speaking service representatives with ability to help a caller 16 with billing inquiries and subgroup 22e may be primary recourses 20 operated by English speaking service representatives with ability to help a caller 16 with technical service issues.

The queuing system 34 may include a queuing table or other similar means for maintaining the order of clients 16 within one or more queues. Each queue is associated with a resource group 22a-228 which services clients within the queue. When a resource 20 within the appropriate resource group 22a-22e becomes available, the next client 16 in the queue associated with the resource group 22a-22e is selected for connection to such available resource 20.

The system 10 comprises an expected wait time calculation system 59 coupled to the queuing system 34 for generating the expected wait time value 15 representing a time duration expected to elapse before the subject client 16 is connected to a resource 20 for servicing.

The expected wait time calculation system 59 comprises an interface 54 to a work force management system 24 for: i) obtaining an agent count 19 indicating a quantity of resources 20 available for servicing clients within each resource group 22a-22e and in particular for the resource group 22a-22e which is servicing clients for the queue within which the subject client 16 is queued; and ii) obtaining a queue identifier 23 identifying which queue the subject client 16 is within (e.g. which resource group 22a-22e is servicing the queue within which the subject client 16 is queued).

The expected wait time calculation system 59 further comprises an interface 56 to the queuing system 34 for obtaining a queue position 21 indicating queue position for the subject client 15 (e.g. the quantity of clients queued for connection to resources 20 prior the subject client 15).

The interface 56 further may obtain an event indicator 17 representing, for each queue, the occurrence of queue decrement events, a duration of time between two successive queue decrement events, or other data useful for determining the duration of time between two successive queue decrement events.

A queue decrement event may comprise a resource answer event wherein a client in queue is connected to a resource 20 within the applicable resource group 22a-22e for servicing and/or other events resulting in a decrement of the quantity of clients queued for servicing prior to the subject client 15. Such other events may include a caller disconnecting or dropping out of queue (or transferring to a different queue) prior to being connected to a resource 20.

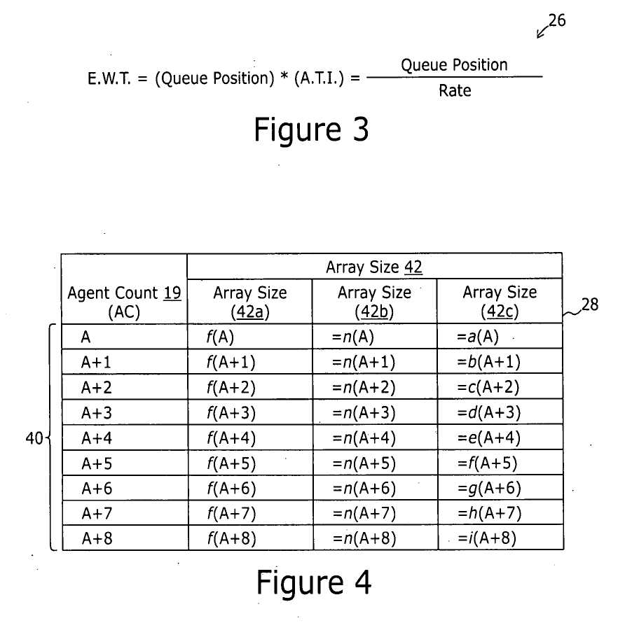

Referring briefly to FIG. 3 in conjunction with FIG. 1, the expected wait time calculation system 59 further comprises an expected wait time model 26 for calculating the expected wait time value 15 as a function of a quantity of clients expected to be serviced prior to the subject client 16 (e.g. the queue position 21) multiplied by a central tendency time interval, such as an average time interval.

The central tendency time interval may be a central measurement, such as an average, of a selected plurality of measured time intervals. Each measured time interval may be the time interval between two successive queue decrement events obtained by the event indicator 17. The quantity of the selected plurality of time intervals used for calculating the central tendency time interval may vary in proportion to the quantity of resources 20 within the applicable resource group 22a-22e available for servicing clients as obtained by the agent count 19.

Stated another way, the expected wait time model 26 calculates the expected wait time value 15 as a function of a quantity of clients expected to be serviced prior to the subject client 16 divided by a rate. The rate is a unit of time divided by the central tendency time interval which may be a central measurement, such as an average, of a selected plurality of measured time intervals.

Again, each measured time interval may be the time interval between two successive queue decrement events and the quantity of the selected plurality of time intervals used for calculating the average time interval may vary in proportion to the quantity of resources 20 within the applicable resource group 22a-22e available for servicing clients.

Returning to FIG. 1, the expected wait time model 26 may comprises an array size model 28 for determining the quantity of measured time intervals (e.g. an array size) to be used for calculation of the central tendency time interval or rate and a dynamic FIFO array 30 for storing measured time interval values useful for calculating the central tendency time interval or rate.

Turning briefly to FIG. 4, an exemplary array size model 28 is represented as a table comprising a plurality of records 40. Each record 40 associates a quantity of available agents (e.g. agent count 19) with an array size 42.

In a first embodiment, the array size 42a may be a mathematical function of the agent count 19 (e.g. agent count 19 is a variable in a function for calculating array size 42a).

In a second embodiment, the array size 42b may be a direct proportion of the agent count 19 whereby the function of calculating array size 42b may be multiplication of the agent count by a predetermined constant (n).

In a third embodiment, the array size 42c may be a proportion of the agent count 19 whereby the function of calculating array size 42c may be multiplication of the agent count by a predetermined value (a) through (i). The predetermined value may be different for each agent count 19.

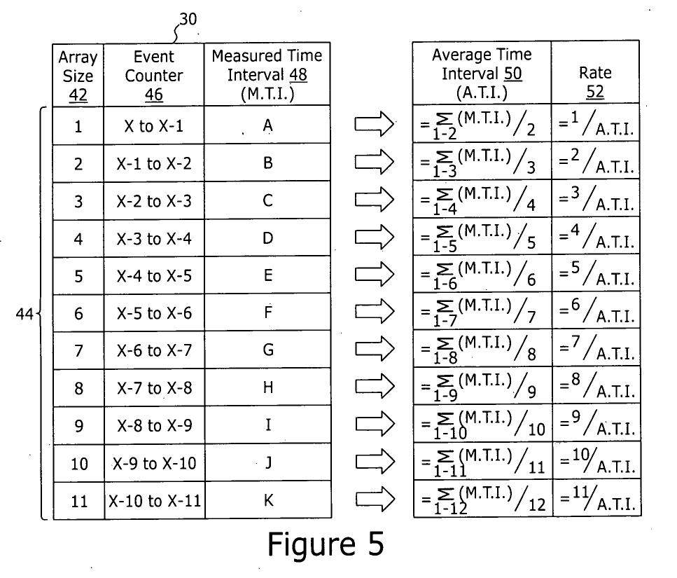

FIG. 5 represents an exemplary FIFO array 30 for a particular queue as a table comprising a plurality of records 44. Each record 44 may include an event counter 46 field and a measured time interval field 48. The event counter field 46 stores a value identifying the two successive queue decrement events between which the measured time interval was measured—and stored in the measured time interval field 48.

For example, the measured time interval value of the first record is the measured time between the most recent queue decrement event (x) and the previous queue decrement event (x−1). The measured time interval value of the second record is the measured time between the previous queue decrement event (x−1) and the prior successive event (x−2).

Upon the occurrence of a queue decrement event 17 (e.g. event (x)), a new record may be written to the top of the table (with each previous record indexing down) and the measured time period elapsed since the previous queue decrement event (x−1) is recorded as the measured time interval 48 of the new record.

As discussed, an array of the most recent measured time interval 48 values are used for calculation of the central tendency time interval 50 and the rate 52. The most recent measured time intervals are at the top of the table as each new queue decrement event results in writing of a new record to the top of the table.

The quantity of measured time intervals used for calculation of the average time interval 50 or rate 52 may be the array size 42 as determined in accordance with the array size model 28 of FIG. 4.

For example, if the array size is (4), the measured time interval 48 for the four events represented by the top four rows of the table 30 are utilized for calculation of the central tendency time interval 50 and the rate 52. In this example, the central tendency time interval 50 may be an average of the measured time intervals 48 wihtin the array.

It should be appreciated that representation of the dynamic array 30 as a table is for illustrative purposes only and those skilled in the art will recognize that other structures for storing an array of values in a FIFO order—wherein the size of the array is dynamic—may be implemented in other comparable data storage structures.

For purposes of facilitating description of the invention, each record 44 of the table 30 may associate with a calculation for the average interval value 50 and a rate 52 useful for the array size 42 represented by the record 44.

In more detail, the calculation for average time interval 50 for a record may be the summation of the measured time intervals from the event represented by such record to the most recent event (e.g. the top record in the table 30) with such sum being divided by the quantity of measured time intervals used in the summation. Similarly the rate 52 value for the record may be a unit of time divided by the central tendency time interval 50.

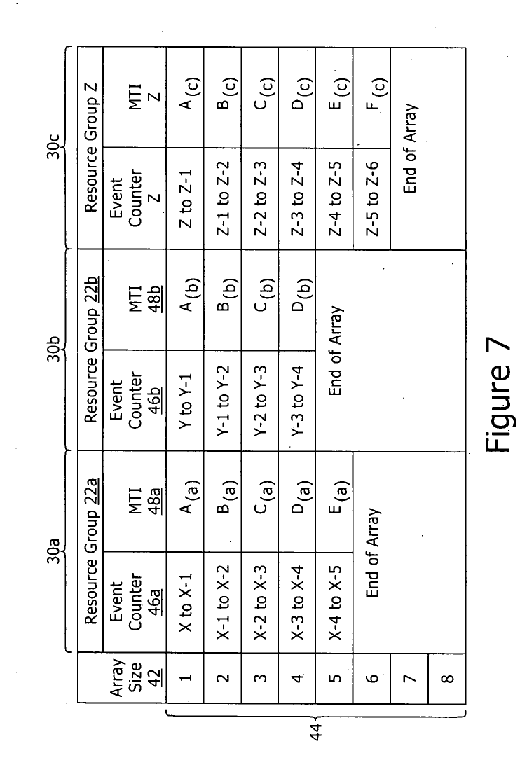

FIG. 7 represents multiple FIFO arrays 30a-30c, each as described with respect to FIG. 5 and each associated with a separate queue for a separate resource group, for example resource groups 22b, 22d, and 22e.

As such, the FIFO array 30a-30c associated with the queue within which the subject client 16 exists may be used for calculation of the expected wait time.

It should be appreciated that because different quantities of resources are available in each of the resource groups 22b, 22c, and 22d, the array size for each FIFO array 30a-30b may be individually calculated based on the quantity of resources within the resource group. Such calculation is as discussed with respect to FIG. 4. For-example, FIFO array 30a may include an array size of five events, FIFO array 30b an array size of four events, and FIFO array 30c an array size of six events.

It should also be appreciated that the measured time intervals 48a, 48b, and 48c stored in each FIFO array 30a, 30b, and 30c are measured time intervals for the queue with which the array is associated.

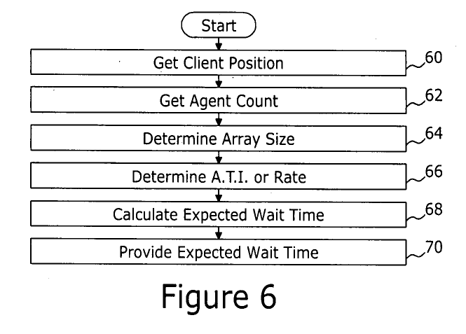

The flow chart of FIG. 6 represents exemplary operation of the expected wait time system 59. Referring to FIG. 6 in conjunction with FIG. 1, Step 60 represents obtaining the queue position 21 of the subject client 16 and step 62 represents obtaining the agent count 19.

Step 64 represents determining the array size 42 as a function of the agent count 19, or more specifically as a direct proportion of the agent count 19. Such determination may be by reference to the array size model 28 of FIG. 4.

Step 66 represents determining the central tendency time interval 50 or the rate 52 for the most recent events—with the quantity of such recent events being the array size. Such step may be by performing the central measurement, such as calculating the average time interval, or rate calculation associated with the record of the dynamic FIFO array 30 (FIG. 5) which corresponds to the array size as determined at step 64.

Step 68 represents determining the expected wait time value 15 utilizing the central tendency time interval 50 or the rate 52 and returning the expected wait time value 15 to one of the subject client 16 or the queuing system 34. Such determination may be by implementation of the expected wait time model 26 as represented by FIG. 3.

Step 70 represents providing the expected wait time value 15 to the client 16 which may be by direct communication to the client 16 or by providing the expected wait time value 15 to the queuing system 34 for provision to the client 16.

Turning to FIG. 2, a second embodiment of the system 10 wherein the queuing system 34 comprises a combination of: i) a traditional queue 36 (such as an ACD) for queuing clients 16 while maintaining the telephony connection (e.g. clients “on-hold”); and ii) a secondary queuing system 38 for queuing clients 16 independent of whether the telephony connection is maintained.

The traditional queue 36 may be embodied as a traditional automated call directors (ACD) which queues clients “on-hold” waiting for a resource 20 within a particular resource group 22a-22e. In more detail, such an ACD may utilize technology for receiving an incoming call from a client 16 (e.g. establishing a client connection) and queuing client connections for connection to a resource 20 within the appropriate resource group 22a-22e and, when one of the resources 20 becomes available, connecting a client from the queue to the available one of the resource—thereby generating a queue decrement event 17.

The secondary queuing system 38 may be coupled to the traditional queue 36 as an accessory device. In general, the secondary queuing system 38 queues clients for connection to resources 20 within a particular resource group 22a-22e in a manner that does not require the client 16 to remain “on-hold” while in the traditional queue 36.

As examples, the secondary queuing system 38 may maintain a client's position in queue for a resource 20 within the appropriate resource group 22a-22e while: i) the client 16 takes advantage of services provided by a secondary resource such as an information on demand system; or ii) the client 16 disconnects and waits for a return call when an appropriate resource is available.

In the example wherein the secondary queuing system 38 maintains the client's position in queue while the client 16 takes advantage of a secondary resource, the secondary queue may, when the client 16 has completed his/her session with the secondary resource and a primary resource 20 within the appropriate resource group 22a-22e is available, generate a priority connection.

The priority connection may be: i) a transfer of the client connection to the traditional queue 36 with a command such that the traditional queue 36 connects the client to the next available one of the resources 20 within the required resource group 22a-22e (e.g. places the client at the front of the queue) thereby generating the queue decrement event 17; or ii) a connection directly to the next available resources 20 within the required resource group 22a-22e (e.g. bypass of the traditional queue 36) thereby generating the queue decrement event 17.

In the example wherein the secondary queuing system 38 maintains the client's position in the queue while the-client 16 disconnects and waits for a return call when an appropriate resource is available, the secondary queue may: i) obtain a means for establishing a telephone connection to the client 16 (e.g. a call back number); and ii) at the appropriate time when a resource is available, induce a call back system to establish a connection to the client 16 utilizing the call back number. Again, a priority connection may then be generated to the available resource 20 within the appropriate resource group 22a-22e thereby-generating the queue decrement event 17.

In summary, it should be appreciated that the systems of the present invention provide for notification of a calling client of an expected wait time that is a more accurate estimate of an expected wait time than traditional calculation models.

Although the invention has been shown and described with respect to certain exemplary embodiments, it is obvious that equivalents and modifications will occur to others skilled in the art upon the reading and understanding of the specification. The present invention includes all such equivalents and modifications, and is limited only by the scope of the following claims.

1. A expected wait time calculation system:
wherein the expected wait time system is adapted to operate with a queuing system and generate an expected wait time value representing a time duration expected to elapse before a subject client is connected to a resource for servicing, the expected wait time calculation system comprising:
an interface to a work force management system, wherein the interface to the work force management system is adapted to obtain an indicator of a quantity of resources available for servicing clients;
an interface to the queuing system, wherein the interface to the queuing system is adapted to obtain an indicator of a queue position for the subject client;
an expected wait time model, wherein the expected wait time model is adapted to calculate the expected wait time value as a function a quantity of clients expected to be serviced prior to the subject client multiplied by a central tendency time interval, the central tendency time interval being a central measurement of a selected plurality of measured time intervals, each between two successive resource queue decrement events, the selected plurality of measured time intervals being a quantity of most recent measured time intervals that is a function of the quantity of resources available for servicing clients.

2. The expected wait time calculation system of claim 1, wherein the function of the quantity of resources available for servicing clients is a proportion calculation comprising multiplying the quantity of agents available for servicing clients by a predetermined value.

3. The expected wait time calculation system of claim 2, wherein the proportion calculation is a direct proportion calculation wherein the predetermined value is independent of the quantity of resources available for servicing clients.

4. The expected wait time calculation system of claim 1, wherein:
the interface to the workforce management system is further adapted to:
obtain an indicator of a first quantity of resources available in a first resource group for servicing clients in a first queue, and
obtain a second quantity of resource available in a second group, distinct from the first group, for servicing clients in a second queue;
the interface to the queuing system is further adapted to obtain indicator of which of the first queue and the second queue the client's queue position is within;
the selected plurality of measured time intervals are: i) measured time intervals for the first queue if the client is positioned within the first queue; and ii) measured time intervals for the second queue if the client is positioned within the second queue; and
the quantity of resources available for servicing clients is: i) the quantity of resources available in the first resource group if the client is within the first queue; and ii) the quantity of resources available in the second resource group if the client is within the second queue.

5. A expected wait time calculation system for generating an expected wait time value representing a time duration expected to elapse before a subject client is connected to a resource for servicing, the expected wait time calculation system comprising:
an interface to a work force management system, wherein the interface to the work force management system is adapted to obtain an indicator of a quantity of resources available for servicing clients;
an interface to a queuing system, wherein the interface to the queuing system is adapted to obtain an indicator of a queue position of the subject client;
a FIFO array, wherein the FIFO array is adapted to store a plurality of measured time intervals, each representing a time period between two successive resource queue decrement events, the FIFO array storing the plurality of measured time intervals in a chronological order;
a central tendency time interval calculator, wherein the central tendency time interval calculator is adapted to determine a central tendency time interval by calculating a central measurement of a selected quantity of those most recently measured time intervals from the FIFO array; and
an expected wait time calculator, wherein the expected wait time calculator is adapted to determine an expected wait time value as a function a quantity of clients expected to be serviced prior to the subject client multiplied by the central tendency time interval; and
a queuing system, wherein the queuing system is adapted to queue the client or connection to the resource and provide the expected wait time value to the client.

6. The expected wait time calculation system of claim 5, wherein the function of the quantity of resources available for servicing clients is a proportion calculation comprising multiplying the quantity of agents available for servicing clients by a predetermined value.

7. The expected wait time calculation system of claim 6, wherein the proportion calculation is a direct proportion calculation wherein the predetermined value is independent of the quantity of resources available for servicing clients.

8. The expected wait time calculation system of claim 5, wherein
the interface to the workforce management system is further adapted to:
obtain an indicator of a first quantity of resources available in a first resource group for servicing clients in a first queue; and
obtain a second quantity of resource available in a second group, distinct from the first group, for servicing clients in a second queue;
the interface to the queuing system is further adapted to obtain an indicator of which of the first queue and the second queue the client's queue position is within;
the FIFO array comprises:
a first FIFO array storing a plurality of measured time intervals for the first queue, and
a second FIFO array storing a plurality of measured time intervals for the second queue, such plurality of measured time intervals for the first queue being distinct from the plurality of measured time intervals for the second queue;
the central tendency time interval calculator is further adapted to determine: i) a first queue central tendency time interval by calculating a central measurement of a first selected quantity of those most recently measured time intervals from the first FIFO array; and ii) a second queue central tendency time interval by calculating an average of a second selected quality of those most recently measured time intervals from the second FIFO array;
the expected wait time calculator is further adapted to determine the expected wait time value: i) as a function of the quantity of clients expect to be serviced prior to the subject client multiplied: i) the first central tendency time interval if the client is within the first queue; and ii) the second central tendency time interval if the client is within the second queue.

9. A expected wait time calculation system:
wherein the expected wait time system is adapted to operate with a queuing system and generate an expected wait time value representing a time duration expected to elapse before a subject client is connected to a resource for servicing, the expected wait time calculation system comprising:
an interface to a work force management system, wherein the interface to the work force management system is adapted to obtain an indicator of a quantity of resources available for servicing clients;
an interface to the queuing system, wherein the interface to the queuing system is adapted to obtain for obtaining an indicator of a queue position for the subject client;
an expected wait time model, wherein the expected wait time model is adapted to calculate the expected wait time value as a function a quantity of clients expected to be serviced prior to the subject client divided by a rate, the rate being a unit of time divided by a central measurement of a selected plurality of measured time intervals, each between two successive resource queue decrement events, the selected plurality of measured time intervals being a quantity of most recent measured time intervals that is a function of the quantity of resources available for servicing clients.

10. The expected wait time calculation system of claim 9, wherein the function of the quantity of resources available for servicing clients is a proportion calculation comprising multiplying the quantity of agents available for servicing clients by a predetermined value.

11. The expected wait time calculation system of claim 10, wherein the proportion calculation is a direct proportion calculation wherein the predetermined value is independent of the quantity of resources available for servicing clients.

12. The expected wait time calculation system of claim 9, wherein
the interface to the workforce management system is further adapted to:
obtain an indicator of a first quantity of resources available in a first resource group for servicing clients in a first queue; and
obtain a second quantity of resource available in a second group, distinct from the first group, for servicing clients in a second queue;
the interface to the queuing system is further adapted to obtain an indicator of which of the first queue and the second queue the client's queue position is within;
the selected plurality of measured time intervals are: i) measured time intervals for the first queue if the client is positioned within the first queue; and ii) measured time intervals for the second queue if the client is positioned within the second queue; and
the quantity of resources available for servicing clients is: i) the quantity of resources available in the first resource group if the client is within the first queue; and ii) the quantity of resources available in the second resource group if the client is within the second queue.

13. A expected wait time calculation system for generating an expected wait time value representing a time duration expected to elapse before a subject client is connected to a resource for servicing, the expected wait time calculation system comprising:
an interface to a work force management system, wherein the interface to the workforce management system is adapted to obtain an indicator of a quantity of resources available for servicing clients;
an interface to a queuing system, wherein the interface to the queuing system is adapted to obtain an indicator of a queue position of the subject client;
a FIFO array, wherein the FIFO array is adapted to store a plurality of measured time intervals, each representing a time period between two successive resource queue decrement events, the FIFO array storing the plurality of measured time intervals in a chronological order;
a central tendency time interval calculator, wherein the central tendency time interval calculator is adapted to determine a rate, the rate being a unit of time divided by a central measurement of a selected quantity of those most recently measured time intervals from the FIFO array; and
an expected wait time calculator, wherein the expected wait time calculator is adapted to determine an expected wait time value as a function a quantity of clients expected to be serviced prior to the subject client divided by the rate; and
a queuing system, wherein the queuing system is adapted to queue the client for connection to the resource and provide the expected wait time value to the client.

14. The expected wait time calculation system of claim 13, wherein the function of the quantity of resources available for servicing clients is a proportion calculation comprising multiplying the quantity of agents available for servicing clients by a predetermined value.

15. The expected wait time calculation system of claim 14, wherein the proportion calculation is a direct proportion calculation wherein the predetermined value is independent of the quantity of resources available for servicing clients.

16. The expected wait time calculation system of claim 13, wherein
the interface to the workforce management system is further adapted to:
obtain an indicator of a first quantity of resources available in a first resource group for servicing clients in a first queue; and
obtain a second quantity of resource available in a second group, distinct from the first group, for servicing clients in a second queue;
the interface to the queuing system is further adapted to obtain an indicator of which of the first queue and the second queue the client's queue position is within;
the FIFO array comprises:
a first FIFO array storing a plurality of measured time intervals for the first queue, and
a second FIFO array storing a plurality of measured time intervals for the second queue, such plurality of measured time intervals for the first queue being distinct from the plurality of measured time intervals for the second queue;
the central tendency time interval calculator is further adapted to determine:
i) a first queue central tendency time interval by calculating a central measurement of a first selected quantity of those most recently measured time intervals from the first FIFO array; and
ii) a second queue central tendency time interval by calculating a central measurement of a second selected quality of those most recently measured time intervals from the second FIFO array;
the expected wait time calculator is further adapted to determine the expected wait time value: i) as a function of the quantity of clients expect to be serviced prior to the subject client multiplied: i) the first central tendency time interval if the client is within the first queue; and ii) the second central tendency time interval if the client is within the second queue.

17. A method of operating an expected wait time system for generating an expected wait time value representing a time duration expected to elapse before a subject client is connected to a resource for servicing, the method comprising:
obtaining an indication of a quantity of resources available for servicing clients;
obtaining an indication of a queue position of the subject client;
storing, in a chronological order, a plurality of measured time intervals, each representing a time period between two successive resource queue decrement events;
calculating a central measurement time interval by calculating a central measurement of a selected quantity of those most recently measured time intervals; and
calculating the expected wait time value as a result of a function a quantity of clients expected to be serviced prior to the subject client and such result being one of: i) multiplied by the central tendency time interval; and ii) divided by a rate, the rate being a unit of time divided by the central tendency time interval; and
providing an indication of the expected wait time to the subject client.

18. The method of claim 17, wherein the function of the quantity of resources available for servicing clients is a proportion calculation comprising multiplying the quantity of agents available for servicing clients by a predetermined value.

19. The method of claim 18, wherein the proportion calculation is a direct proportion calculation wherein the predetermined value is independent of the quantity of resources available for servicing clients.

20. The method of claim 17, wherein:
the method further comprises obtaining an indicator of which of the first queue and the second queue the client's queue position is within; and wherein
obtaining an indication of a quantity of resources available for servicing clients comprises obtaining an indicator of a first quantity of resources available in a first resource group for servicing clients in a first queue and an indicator of a second quantity of resource available in a second group, distinct from the first group, for servicing clients in a second queue;
the selected plurality of measured time intervals are: i) measured time intervals for the first queue if the client is positioned within the first queue; and ii) measured time intervals for the second queue if the client is positioned within the second queue; and
the quantity of resources available for servicing clients is: i) the quantity of resources available in the first resource group if the client is within the first queue; and ii) the quantity of resources available in the second resource group if the client is within the second queue.
